(19) United States
(12) Patent Application Publication
(10) Pub. No.: US 2024/0321088 A1
(43) Pub. Date: Sep. 26, 2024

(54) VEHICLE-BASED DATA AGGREGATION AND PROCESSING

(71) Applicant: PANASONIC CORPORATION OF NORTH AMERICA D/B/A SMART MOBILITY OFFICE, DENVER, CO (US)

(72) Inventor: LAUREN CORDOVA, LITTLETON, CO (US)

(21) Appl. No.: 18/610,649

(22) Filed: Mar. 20, 2024

Related U.S. Application Data
(60) Provisional application No. 63/453,487, filed on Mar. 21, 2023.

(51) Int. Cl. G08G 1/01; G07C 5/06

(52) U.S. Cl. CPC G08G 1/0133; G07C 5/06

(57) ABSTRACT

Methods of and systems for aggregating and processing information in a connected vehicle system are provided. For example, the method includes receiving a plurality of vehicle messages from one or more transmission units, storing each of the vehicle messages on a computer readable medium operably coupled to the processor, aggregating the stored messages based upon at least a message type indicator to produce a set of aggregated vehicle messages, storing the set of aggregated vehicle messages for further analysis and processing, and performing further processing on the set of aggregated vehicle messages request to generate at least one requested output. The system includes various components such as at least one network interface, a computer-readable medium, and at least one processor operably connected and configured to perform the above-identified method.

### CROSS-REFERENCE TO RELATED APPLICATION

The present application claims benefit of U.S. Provisional Application No. 63/453,487, filed Mar. 21, 2023, the disclosure of which is hereby incorporated by reference in its entirety for all purposes.

### FIELD OF THE INVENTION

The present disclosure relates to the field of vehicle automation and/or assistance and, in particular, to aggregation of data received from one or more vehicles.

### BACKGROUND

Vehicles today generate a lot of data, and there is increased interest in collecting data from connected vehicles to support various roadway safety, mobility, and other use cases. Connected Vehicle (CV) data is data collected/received from vehicles on the road, including location, speed, and potentially other contextual data elements. In some examples, the additional data can include data such as wiper status, traction control status, etc. depending on the data source.

There are various types of vehicle communication systems. Vehicle-to-everything (V2X) communications includes devices and systems that allow one or more vehicles to communicate with other vehicles (using, for example, vehicle-to-vehicle (V2V) communications), infrastructure (using, for example, vehicle-to-infrastructure (V2I) communications), and/or pedestrians (using, for example, vehicle-to-pedestrian (V2P) communications). Intelligent Transportation Systems (ITS) sometimes utilize V2X systems to manage traffic flow, manage lane occupancy, facilitate toll collection, track freight, provide road condition alerts, and the like. Most ITS applications rely on the situation or cooperative awareness, which is based on periodic and event-driven broadcast of messages such as basic safety messages (BSM) between vehicles and other data collecting/receiving devices.

V2X datasets are specific CV datasets that are standards based to ensure interoperability across vehicle types and jurisdictions. Today, V2X deployments include On-Board Units (OBUs) installed in vehicles that aggregate, transmit, and process V2X data; RoadSide Units (RSUs) to collect V2X data from nearby vehicles and transmit certain data to vehicles; and cloud-based backend processing of V2X data. One of the primary use cases for standards-based V2X communications is real-time safety applications such as in-vehicle safety alerts for other vehicles or intersection states (e.g. red-light violation warning). As such, V2X data is meant to be transmitted at high-frequency, and messages can be sent up to 10× per second per device and message type, leading to high data volumes. According to a 2018 Statista Connected Car Report, 105 million connected cars could generate 20 TB of data per hour, or 150 PB of data per year.

### SUMMARY

In at least one example as described herein, a method of aggregating and processing information in a connected vehicle system is provided. The method includes receiving a plurality of vehicle messages from one or more transmission units, storing each of the vehicle messages on a computer readable medium operably coupled to the processor, aggregating the stored messages based upon at least a message type indicator to produce a set of aggregated vehicle messages, storing the set of aggregated vehicle messages for further analysis and processing, and performing further processing on the set of aggregated vehicle messages request to generate at least one requested output.

Implementations of the method of aggregating and processing information in a connected vehicle system can include one or more of the following features.

In examples of the method, performing further processing includes determining one or more performance metrics for a particular intersection. In some examples, the one or more performance metrics for an intersection include at least a measurement of traversal time for a particular vehicle through the intersection. In some examples, the method can further include determining a first priority request message in the set of aggregated vehicle messages, the first priority request message indicating that the particular vehicle is requesting to traverse the intersection; determining one or more priority request update messages in the set of aggregated vehicle messages, the one or more priority request update messages indicating that the particular vehicle is continuing to approach the intersection; determining a first request cancellation message in the set of aggregated vehicle message, the first request cancellation message indicating that the particular vehicle has traversed the intersection; and determining a traversal time for the particular vehicle through the intersection based upon timestamp information associated with the first priority request message and the first request cancellation message. In some examples, the one or more performance metrics for a particular intersection can include one or more of total number of vehicles passing through the intersection, total number of priority vehicles passing through the intersection, and traversal time information for vehicles passing through the intersection.

In examples of the method, performing further processing can include determining aggregated overall request response information for a particular intersection based upon signal status messages for the particular intersection as identified in the set of aggregated vehicle messages.

In some examples of the method, performing further processing can include determining packet error ratio information for one or more devices associated with the connected vehicle system based upon the set of aggregated vehicle messages. In some examples, determining the packet error ratio information includes calculating the number of dropped or missing packets over a period of time for the one or more devices associated with the connected vehicle system.

In another examples, a system for aggregating and processing information in a connected vehicle system is provided. The system can include at least one network interface configured to receive a plurality of vehicle messages from one or more roadside transmission units, a computer readable medium operably coupled to the at least one network interface and configured to store each of the vehicle messages, and at least one processor operably coupled to the at least one network interface and the computer readable medium. The at least one processor can be configured to aggregate the stored messages based upon at least a message type indicator to produce a set of aggregated vehicle messages, store the set of aggregated vehicle messages on the computer readable medium for further analysis and processing, and perform further processing on the set of aggregated vehicle messages request to generate at least one requested output.

Implementations of the system for aggregating and processing information in a connected vehicle system can include one or more of the following features.

In examples of the system, the at least one processor is configured to perform further processing by being further configured to determine one or more performance metrics for a particular intersection. In some examples, the one or more performance metrics for an intersection include at least a measurement of traversal time for a particular vehicle through the intersection. In some further examples, the at least one processor can be further configured to determine a first priority request message in the set of aggregated vehicle messages, the first priority request message indicating that the particular vehicle is requesting to traverse the intersection; determine one or more priority request update messages in the set of aggregated vehicle messages, the one or more priority request update messages indicating that the particular vehicle is continuing to approach the intersection; determine a first request cancellation message in the set of aggregated vehicle message, the first request cancellation message indicating that the particular vehicle has traversed the intersection; and determine a traversal time for the particular vehicle through the intersection based upon timestamp information associated with the first priority request message and the first request cancellation message. In some examples, the one or more performance metrics for a particular intersection can include one or more of total number of vehicles passing through the intersection, total number of priority vehicles passing through the intersection, and traversal time information for vehicles passing through the intersection.

In examples of the system, the at least one processor can be configured to perform further processing by being further configured to determine aggregated overall request response information for a particular intersection based upon signal status messages for the particular intersection as identified in the set of aggregated vehicle messages.

In some examples of the system, the at least one processor can be configured to perform further processing by being further configured to determine packet error ratio information for one or more devices associated with the connected vehicle system based upon the set of aggregated vehicle messages. In some examples, the at least one processor can be configured to determine the packet error ratio information by being further configured to calculate the number of dropped or missing packets over a period of time for the one or more devices associated with the connected vehicle system.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and are incorporated in and constitute a part of this specification but are not intended as a definition of the limits of any particular example. The drawings, together with the remainder of the specification, serve to explain principles and operations of the described and claimed aspects. In the figures, each identical or nearly identical component that is illustrated in various figures is represented by a like numeral. For purposes of clarity, not every component may be labeled in every figure.

FIG. 1 is a block diagram of a sample connected vehicle, in accordance with at least one example of the present disclosure.

FIG. 2 is a block diagram of a sample connected vehicle system, in accordance with at least one example of the present disclosure.

FIG. 3 is a flow diagram illustrating a sample data collection process, in accordance with at least one example of the present disclosure.

FIG. 4. is a sample received message, in accordance with at least one example of the present disclosure.

FIG. 5A is a sample geographical representation of map message information including ingress and egress lane information, in accordance with at least one example of the present disclosure.

FIG. 5B is a sample geographical representation of a vehicle passing through an intersection and the associated request messages transmitted by the vehicle, in accordance with at least one example of the present disclosure.

FIG. 6 is a sample flow chart illustrating a process for determining one or more intersection metrics including traversal time, in accordance with at least one example of the present disclosure.

FIG. 7 is a sample flow chart illustrating a process for determining one or more metrics related to packet error in a connected vehicle system, in accordance with at least one example of the present disclosure.

FIG. 8 is a sample computing device configured to implement at least one process as disclosed herein, in accordance with at least one example of the present disclosure.

### DETAILED DESCRIPTION

The present disclosure is directed to optimization of collecting and aggregating V2X data in a connected vehicle system. However, the present disclosure is also directed to supporting processing and analysis of the aggregated V2X data to determine one or more performance measurements and metrics for one or more aspects of the connected vehicle system. Historically, V2X data collectors have been collecting and storing all messages received. Analysis of such information may be feasible at low volume of V2X deployment or in environments where overlapping device coverage does not exist. However, data management and storage will become increasingly more expensive and difficult to process at scale as automotive manufacturers begin to deploy on-board units (OBUs) in more cars and more departments of transportation deploy roadside units (RSUs) to interact with these equipped vehicles. As more OBUs and RSUs are deployed, the additional collected information can be further analyzed to determine more performance information related to the operation of connected vehicle systems.

The present disclosure is directed to systems and methods of optimizing data collection, aggregation, and analysis in a connected vehicle system such as a V2X vehicle system. For example, a computer-implemented method of aggregating and processing information in a connected vehicle system can include receiving, by at least one processor, a plurality of vehicle messages from one or more transmission units and storing the vehicle messages on a computer readable medium operably coupled to the processor. Once stored, the processor can aggregate the stored messages based upon at least a message type indicator to produce a set of aggregated vehicle messages and further store the set of aggregated vehicle messages for further analysis and processing. The set of aggregated vehicle messages are then available for further processing to generate, for example, at least one requested output. For example, the processor can further process the aggregated vehicle messages to determine intersection metrics (e.g., traversal times), packet error rates for the system, overall system performance, and other related performance measurements and metrics.

Examples of the methods, systems, and processes discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

### Sample Connected Vehicle

In some examples, a connected vehicle can be configured to collect information related to operation of the vehicle and distribute this information to one or more receiving devices. In certain implementations, a connected vehicle can be configured to transmit a basic safety message (BSM) ten times per second. Nearby receiving devices such as other connected vehicles and roadside equipment such as RSUs receive the messages.

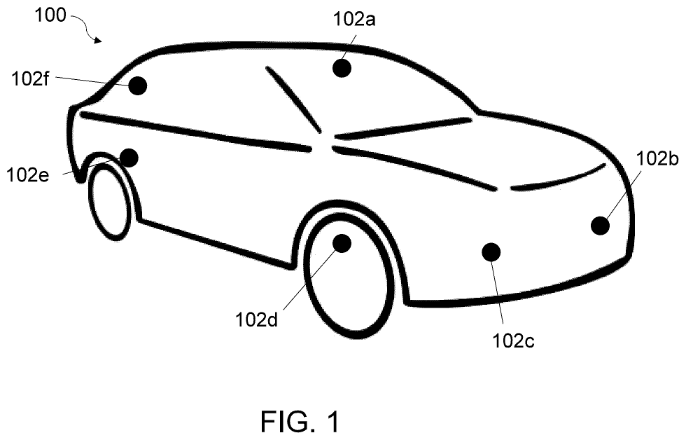

Typically, a BSM can include contextual data about what is happening on a vehicle. The information contained within a typical BSM is based upon information collected from a series of sensors integrated into a connected vehicle. For example, FIG. 1 illustrates a connected vehicle 100. As shown in FIG. 1, the connected vehicle 100 can include a number of sensors 102a-102f, collectively referred to herein as sensors 102. For example, the connected vehicle 100 can include a lane departure sensor 102a, an active park assist sensor 102b, a front object sensor 102c, a tire pressure sensor 102d, a wheel speed sensor 102e, and a rear object sensor 102f. However, it should be noted that the sensors 102 as shown in FIG. 1 are provided by way of example only. In some examples, a connected vehicle can include fewer or more sensors than those as shown in FIG. 1. For example, a connected vehicle can include one or more of lane departure sensors, night vision sensors, front object cameras, vehicle speed sensors, pedestrian warning sensors, airbag sensors, front object sensors, active park assist sensors, tire pressure sensors, rear object cameras, side curtain sensors, blind spot detection sensors, cross traffic alert sensors, wheel speed sensors, collision sensors, steering angle sensors, adaptive cruise control sensors, automatic brake actuator sensors, and other similar connected vehicle sensors.

### Connected Vehicle System and Data Collection

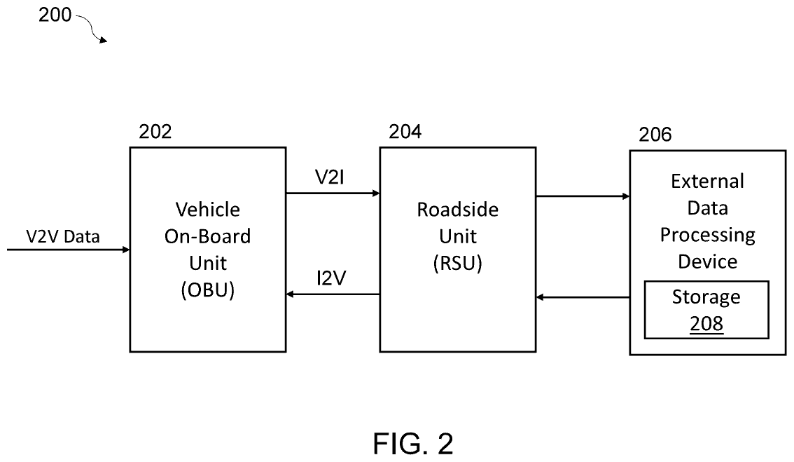

FIG. 2 illustrates a sample vehicle communication system 200. As shown in FIG. 2, one or more processing devices can be configured to communicate via one or more data communication connections to exchange data therebetween. For example, as shown in FIG. 2, the system 200 can include a vehicle onboard unit 202, a roadside unit 204, and external data processing device 206. As further shown in FIG. 2, the OBU 202 can be configured to receive V2V data from one or more additional vehicles located in close proximity to the OBU 202. The OBU 202 can be further configured to transmit data collected related to the vehicle associated with the OBU 202 to the RSU 204. For example, OBU 202 can be configured to transmit the collected data to the RSU 204 as a vehicle-to-infrastructure (V2I) communication.

As further shown in FIG. 2, the RSU 204 can be configured to receive the V2I communication from the OBU 202. The RSU 204 can be further configured to process the received information and transmit at least a portion of the information to the external data processing device 206. In certain examples, the RSU 204 can be configured to transmit the information as encoded vehicle data. The device 206 can be configured to receive the information from the RSU 204 and store the received information at storage 208. As described herein, the storage 208 can be implemented as a computer-readable medium operably coupled to the external data processing device 206 such that information stored on storage 208 is accessible to the device 206.

As also shown in FIG. 2, the external data processing device 206 can be configured to transmit data to the RSU 204. The RSU 204 can be configured to process the received information and, if applicable, transmit at least a portion of the received information to the OBU 202 as, for example, an infrastructure-to-vehicle (12V) communication.

It should be noted that, as used herein, V2X communications can include all communication directions and inter-device combinations as described herein. For example, V2X communications can include V2V communications, V2I communications, 12V communications, and other similar inter-device communications associated with a smart vehicle data collection system as described herein.

In such an example system as shown in FIG. 2, data collected by the OBU 202 about the connected vehicle in which the OBU 202 is installed is transmitted to the external data processing device 206 the RBU 204. The device 206 can be configured to analyze the messages and data collected by the OBU 202 to detect any events that are to be communicated back to the OBU 202 such as updated traffic condition information, emergency information, and other similar information. The device 206 is configured to transmit such event information back to the OBU 202 via the RBU 204 as further shown in FIG. 2.

In addition to BSMs as described above, information received from one or more connected vehicles can further include signal request messages (SRMs). For example, an RSU can receive an SRM when a vehicle is requesting priority or preemption at an intersection. In some examples, each “request” can generate multiple messages (SRMs), including an initial message type when the request is first initiated, updated messages as the vehicle gets closer to the middle of an intersection, and finally messages to let the intersection know that the vehicle has made it through. Therefore, a count of SRMs would review a higher number of messages that result from much fewer vehicle request attempts. Therefore, as described herein below, to properly determine additional information related to a vehicle passing through an intersection (such as, for example, total traversal time), additional processing and aggregation of the SRMs as received can be performed.

As such, and as noted above, as the number of connected vehicles continues to increase, so too does the data collected by those connected vehicles (e.g., BSMs, SRMs, and other similar messages received from connected vehicles), the amount of information that can be determined and analyzed related to, for example, movement of connected vehicles, intersection performance (e.g., average traversal times), and other similar information can be determined and analyzed.

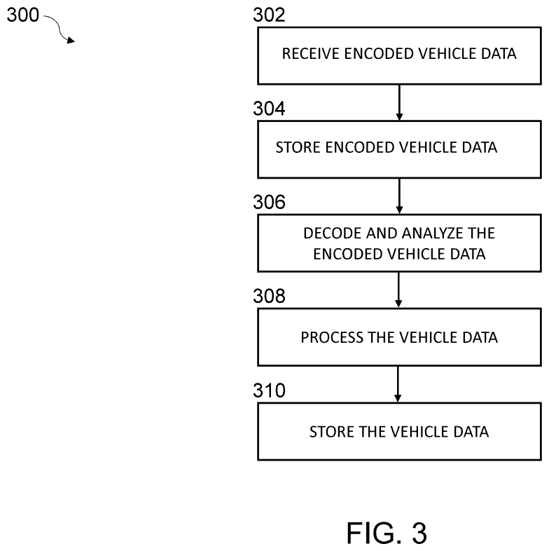

FIG. 3 illustrates a process 300 for use in receiving and storing information in a connected vehicle system as described herein. The process 300, including steps 302, 304, 306, 308, and 310, can be implementing by a processing device such as the external data processing device 206 as shown in FIG. 2 and described above.

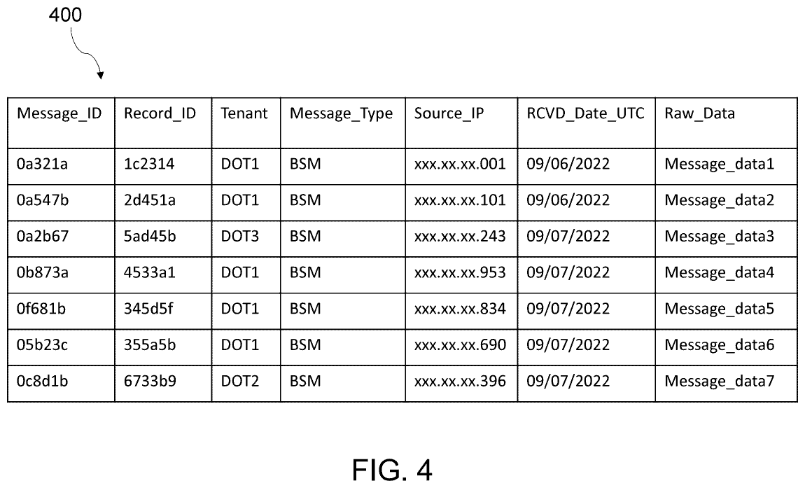

As shown in FIG. 3, process 300 begins when the processing device receives 302 the encoded vehicle data. For example, as described herein, the encoded vehicle data can be received from an RSU such as RSU 204 as shown in FIG. 2 and described above. In some examples, the received encoded vehicle data can include information contained in BSMs, SRMs, and other similar data messages. FIG. 4 illustrates a sample portion of a data structure 400 configured to store a set of received encoded vehicle data. For example, as shown in FIG. 4, the data structure 400 can include various data such as Message_ID, Record_ID, Tenant, Message_Type, Source_IP, RCVD_Date_UTC, and Raw_Data. In some examples, the Message_ID can be a number generated based upon additional information contained within the message (e.g., an analysis of the hexadecimal value of the Raw_Data field) and assigned to each received message. The Record_ID can be a unique number arbitrarily assigned to each message. As such, multiple messages (having the same Raw_Data) may have the same Message_ID while still having a unique Record_ID. Additionally, the Tenant field can indicate the owner and/or source of the information. For example, the Tenant can be a state department of transportation, a national transportation agency, a vehicle manufacturer, and other similar organizations. The Message_Type can represent what type of message data is contained within the message. For example, message types can include BSMs, SRMs, map data messages, signal phase and timing messages, signal status messages, and other similar types of messages.

As further shown in data structure 400, the Source_IP field can include an Internet Protocol (IP) address of the transmitting device that the message was received from. For example, the Source_IP can be the IP address of an RSU (e.g., RSU 204 as shown in FIG. 2) that has transmitted the vehicle message to a central data processing and storage system (e.g., external data processing device 206 as shown in FIG. 2). The RCVD_Date_UTC field can include timestamp information related to when the message was received. The Raw_Data field can include the encoded message data (e.g., encoded as hexadecimal data).

It should be noted that data structure 400 is provided by way of example only. In some examples, the data structure can include additional or fewer data organized, for example, in correspondingly more or less columns. For example, additional timestamp information can be collected, information related to the encoding of the message, system environment information, and other similar information collected from one or more connected vehicles as described herein.

Referring back to FIG. 3, after receiving 302 the encoded vehicle data, the processing device can store 304 the encoded vehicle data. For example, the processing device can store 304 the encoded vehicle data on a computer-readable medium operably connected to the processing device such as storage 208 as shown in FIG. 2 and described above. As further shown in FIG. 3, the processing device can decode and analyze 306 the encoded vehicle data to determine one or more characteristics of the encoded vehicle data such as, for example, message type. For example, the processing device can parse the stored information for the encoded data, decode and analyze 306 the message type data field for the stored vehicle data and deduplicate messages by, for example, removing particular message data and fields such as Message_ID and/or Source_IP as noted above such that each message is only reported once. Based upon the resulting analysis 306 of the encoded vehicle data, the processing device can identify one or more deduplicative and unique messages as included in the decoded vehicle data as described herein. As further shown in FIG. 3, the processing device can perform additional processing 310. For example, the processing device can be configured to further process 310 the vehicle data to determine any changes between messages as determined by message type. The processing device can further store 312 the vehicle data for additional analysis at, for example, a later time.

It should be noted that the process 300 as shown in FIG. 3 is provided by way of example only. Various steps as included in the process 300 can be altered based upon implementation. For example, FIGS. 4A and 4B illustrate alternate implementations for various steps as included in the process 300.

### Data Aggregation and Metric Analysis

As described herein, the collected information from a V2X system can be collected and used to calculate various metrics. For example, the information can be used to analyze an individual intersection including number of vehicles passing through an intersection, number of emergency/priority vehicles passing through the intersection, and average traversal time through the intersection. Additional information about a V2X system can be determined such as packet error ratio as calculated based upon the number of messages dropped by one or more receiving devices (e.g., RSUs) in a V2X system.

In some examples, the overall number and information contained in various messages such as SRMs can be aggregated to determine how many vehicles requested priority or preemption service at an intersection as well as other basic statistics about their traversal through the intersection. For example, the aggregated data can be used to calculate the time a vehicle takes to traverse an intersection using MAP message information for a defined starting point at, for example, the beginning of an ingress lane to an intersection and MAP message information for a defined end point at the start of an egress lane. Such a calculation of traversal time can be applicable to both SRMs (for vehicles requesting priority/preemption) and BSMs (for general vehicles).

More specifically, in some examples, a MAP message is designed to convey geographic road information to a receiving device. For example, as described herein, a MAP message can be configured to convey one or more intersection lane geometry maps within a single message. The MAP message content can include such items as complex intersection descriptions, road segment descriptions, high speed curve outlines, segments of roadways, and other similar geographic information. A single MAP message can be configured to convey descriptions of one or more geographic areas and/or intersections. The contents of such a message can define one or more details of indexing systems that are in turn used by other messages to relate additional information to events at specific geographic locations on the roadway.

Additionally, the aggregated data can be used to analyze an individual intersection's response to a received request. For example, aggregation of signal status messages (SSMs) can be used to document an intersection's complete response to a priority requesting, including time to process the request and ultimately whether the intersection granted of denied the request (as applicable). In some other examples, the aggregated data can be used to computer a packet error ration indicative of the number of packets dropped by, for example, an individual RSU over a defined timeframe. Such a calculation can be used to determine device/system health over a period of time and, if necessary, identify problem devices within a V2X system.

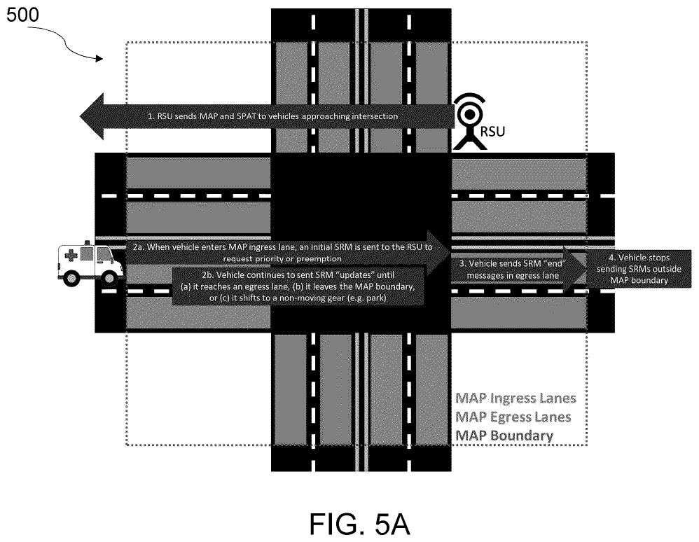

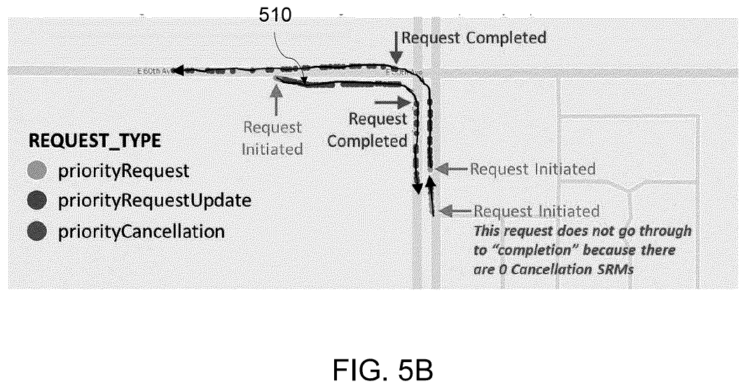

As described herein, a MAP message can be transmitted by one or more RSUs to any connected vehicles geographically in range of the transmitting unit. The MAP message may include various information about an upcoming intersection that the vehicle can use when approaching the intersection to, for example, generate one or more SRMs. As shown in FIG. 5A, information included in the MAP message 500 can include ingress lane position and starting point information. As used herein, an ingress lane represents the lane a vehicle is to use to traverse an intersection (including, for example, dedicated turning lanes, dedicated non-turning lanes, and combination turning/non-turning lanes). The MAP message can further include information related to egress lane position and starting points. For a particular intersection's MAP message, each defined ingress lane has a corresponding egress lane.

By using the information contained within the MAP message, a connected vehicle can both determine when it is approaching an intersection as well as how to proceed through the intersection. For a priority vehicle, as the vehicle approaches the beginning of the intersection (as defined by, for example, the start of the ingress lane as defined by the MAP message), the vehicle can transmit a priority request message (priorityRequest). As the vehicle processes through the ingress lane, the vehicle can continue to broadcast priority request update messages (priorityRequestUpdate). Once the vehicle has reached the start point of the egress lane, the vehicle can transmit a priority cancellation message (priorityCancellation) indicating that the request to traverse the intersection is completed as the vehicle is now in the egress lane.

FIG. 5B illustrates a sample map with a set of SRMs. Following line 510, as the vehicle approaches the intersection it initially transmits a priorityRequest message and the request to traverse the intersection is initiated. Continuing to follow line 510, as the vehicle approaches the intersection it continues to transmit priorityRequestUpdate messages. Upon traversal of the intersection and passing the starting point of the egress lane, the vehicle transmits a priorityCancellation message and the request is complete. In some examples, the vehicle may continue to transmit priorityCancellation messages until the vehicle is outside of the intersection boundary as defined by, for example, the MAP message.

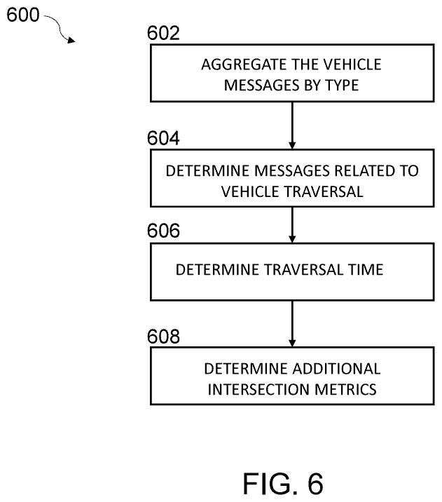

FIG. 6 illustrates a sample process flow 600 for determining one or more intersection metrics based upon aggregated vehicle messages as described herein. The process 600, including steps 602, 604, 606, and 608, can be implementing by a processing device such as the external data processing device 206 as shown in FIG. 2 and described above.

As shown in FIG. 6, a processing device can aggregate 600 the vehicle messages by, for example, type. In some examples, the aggregation can be based upon whether the message is a priority request message. As further shown in FIG. 6, the processor can determine 604 messages related to a particular vehicle traversal through the intersection. For example, the processor can determine 604 messages related to a specific vehicle based upon vehicle identification information contained within the messages. The processor can further determine 604 an individual type of request message as described above, e.g., a priority request message, a priority update message, and a priority cancellation message as described above in reference to, for example, FIGS. 5A and 5B.

As further shown in FIG. 6, and based upon the determined messages, the processor can determine 606 traversal time through the intersection for a particular vehicle. For example, the processor can determine 606 the amount of time from receiving the first priority request message to traverse the intersection until receiving the first request cancellation message indicating the vehicle has traversed the intersection has entered the egress lane. The processor can also be configured to determine 608 additional intersection metrics such as total number of vehicles passing through the intersection, total number of priority vehicles passing through the intersection, average traversal times for all vehicles traversing the intersection, individual traversal times for vehicles passing through the intersection, and other similar intersection metrics.

Additionally, the processor can further determine 608 additional information based upon analysis of the SSMs as generated by a particular device in a connected vehicle system. For example, the processor can determine 608 various metrics related to an intersection's response to a request such as total time to process/respond to a request, number of priority requests per day at an intersection, total number of requests per day at an intersection, total average wait and traversal times at an intersection, and other similar additional information.

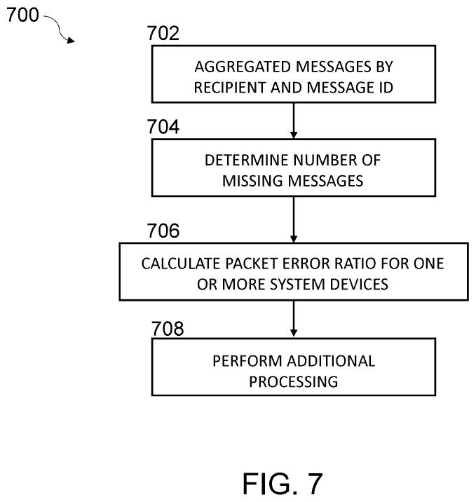

FIG. 7 illustrates a sample process flow 700 for determining one or more system performance metrics such as packet error ratios based upon aggregated vehicle messages as described herein. The process 700, including steps 702, 704, 706, and 708, can be implementing by a processing device such as the external data processing device 206 as shown in FIG. 2 and described above.

As shown in FIG. 7, the processor can aggregate 702 messages by various information as contained within the message such as, for example, recipient ID and message ID information. Based upon the message ID information, the processor can further determine 704 the number of missing messages intended for a particular recipient device (as further defined by the recipient information contained within the messages). For example, the message ID numbers can be an integer value that is incremented by one as each message is sent. By determining the number of missing messages based upon missing message ID information, the processor can determine 704 the total number of missing messages for a particular recipient device.

As further shown in FIG. 7, the processor can calculate 706 a packet error ratio for one or more system devices based upon the determined number of missing messages. For example, the calculation can include dividing the total number of received messages at a particular recipient device by the number of total messages sent to the recipient device (the sum of the total messages received and the number of determined missing messages). Based upon the calculated packet error ratio, the processor can perform 708 additional processing or analysis. For example, the processor can determine the current health or functionality of a particular system device (e.g., a particular RSU) based upon its associated packet error ratio as calculated herein. In such an example, poorly performing system devices within a connected vehicle system can be replaced and/or repaired to better improve the overall efficiency and operation of the connected vehicle system.

It should be noted that the processes 600 and 700 as shown in FIGS. 6 and 7 are provided by way of example only. The individual steps as shown in each of processes 600 and 700 can be altered based upon the design and integration of a connected vehicle system as described herein. As such, the processes as shown FIGS. 6 and 7 are for illustrative purposes only and are not intended to unduly limit the disclosure as described herein.

### Sample Computing System

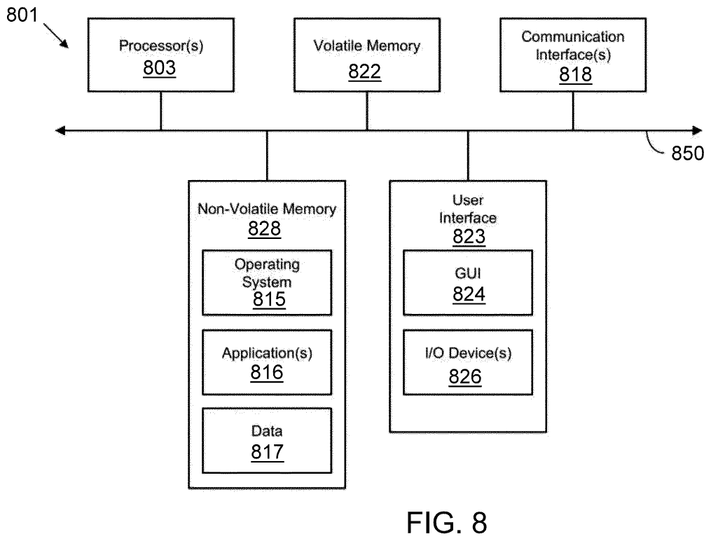

FIG. 8 depicts a block diagram of a computing device 801 useful for practicing the computing and/or processing devices as described herein and implementing the processes as shown, for example, in FIGS. 3, 6, and 7 and described above. The computing device 801 includes one or more processors 803, volatile memory 822 (e.g., random access memory (RAM)), non-volatile memory 828, user interface (UI) 823, one or more communications interfaces 818, and a communications bus 850. The computing device 801 may also be referred to as a computer or a computer system.

The non-volatile memory 828 can include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

The user interface 823 can include a graphical user interface (GUI) 824 (e.g., a touchscreen, a display, etc.) and one or more input/output (I/O) devices 826 (e.g., a mouse, a keyboard, a microphone, one or more speakers, one or more cameras, one or more biometric scanners, one or more environmental sensors, and one or more accelerometers, etc.).

The non-volatile memory 828 stores an operating system 815, one or more applications 816, and data 817 such that, for example, computer instructions of the operating system 815 and/or the applications 816 are executed by processor(s) 803 out of the volatile memory 822. In some examples, the volatile memory 822 can include one or more types of RAM and/or a cache memory that can offer a faster response time than a main memory. Data can be entered using an input device of the GUI 824 or received from the I/O device(s) 826. Various elements of the computer 801 can communicate via the communications bus 850.

The illustrated computing device 801 is shown merely as an example client device or server and can be implemented by any computing or processing environment with any type of machine or set of machines that can have suitable hardware and/or software capable of operating as described herein.

The processor(s) 803 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A processor can perform the function, operation, or sequence of operations using digital values and/or using analog signals.

In some examples, the processor 803 can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multicore processors, or general-purpose computers with associated memory.

The processor 803 can be analog, digital or mixed. In some examples, the processor 803 can be one or more physical processors, or one or more virtual (e.g., remotely located or cloud) processors. A processor including multiple processor cores and/or multiple processors can provide functionality for parallel, simultaneous execution of instructions or for parallel, simultaneous execution of one instruction on more than one piece of data.

The communications interfaces 818 can include one or more interfaces to enable the computing device 801 to access a computer network such as a LAN, a WAN, a Personal Area Network (PAN), or the Internet through a variety of wired and/or wireless connections, including cellular connections.

Having thus described several aspects of at least one example, it is to be appreciated that various alterations, modifications, and improvements will readily occur to those skilled in the art. For instance, examples disclosed herein can also be used in other contexts. Such alterations, modifications, and improvements are intended to be part of this disclosure and are intended to be within the scope of the examples discussed herein. Accordingly, the foregoing description and drawings are by way of example only.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

What is claimed is:

1. A method of aggregating and processing information in a connected vehicle system, the method comprising:
receiving, by at least one processor, a plurality of vehicle messages from one or more transmission units;
storing, by the at least one processor, each of the vehicle messages on a computer readable medium operably coupled to the processor;
aggregating, by the at least one processor, the stored messages based upon at least a message type indicator to produce a set of aggregated vehicle messages;
storing, by the at least one processor, the set of aggregated vehicle messages for further analysis and processing; and
performing, by the at least one processor, further processing on the set of aggregated vehicle messages request to generate at least one requested output.

2. The method of claim 1, wherein performing further processing comprises determining one or more performance metrics for a particular intersection.

3. The method of claim 2, wherein the one or more performance metrics for an intersection comprise at least a measurement of traversal time for a particular vehicle through the intersection.

4. The method of claim 3, further comprising:
determining, by the at least one processor, a first priority request message in the set of aggregated vehicle messages, the first priority request message indicating that the particular vehicle is requesting to traverse the intersection;
determining, by the at least one processor, one or more priority request update messages in the set of aggregated vehicle messages, the one or more priority request update messages indicating that the particular vehicle is continuing to approach the intersection;
determining, by the at least one processor, a first request cancellation message in the set of aggregated vehicle message, the first request cancellation message indicating that the particular vehicle has traversed the intersection; and
determining, by the at least one processor, a traversal time for the particular vehicle through the intersection based upon timestamp information associated with the first priority request message and the first request cancellation message.

5. The method of claim 2, wherein the one or more performance metrics for a particular intersection comprise one or more of total number of vehicles passing through the intersection, total number of priority vehicles passing through the intersection, and traversal time information for vehicles passing through the intersection.

6. The method of claim 1, wherein performing further processing comprises determining aggregated overall request response information for a particular intersection based upon signal status messages for the particular intersection as identified in the set of aggregated vehicle messages.

7. The method of claim 1, wherein performing further processing comprises determining packet error ratio information for one or more devices associated with the connected vehicle system based upon the set of aggregated vehicle messages.

8. The method of claim 7, wherein determining the packet error ratio information comprises calculating the number of dropped or missing packets over a period of time for the one or more devices associated with the connected vehicle system.

9. A system for aggregating and processing information in a connected vehicle system, the system comprising:
at least one network interface configured to receive a plurality of vehicle messages from one or more roadside transmission units;
a computer readable medium operably coupled to the at least one network interface and configured to store each of the vehicle messages; and
at least one processor operably coupled to the at least one network interface and the computer readable medium, the at least one processor being configured to:
aggregate the stored messages based upon at least a message type indicator to produce a set of aggregated vehicle messages,
store the set of aggregated vehicle messages on the computer readable medium for further analysis and processing, and
perform further processing on the set of aggregated vehicle messages request to generate at least one requested output.

10. The system of claim 9, wherein the at least one processor is configured to perform further processing by being further configured to determine one or more performance metrics for a particular intersection.

11. The system of claim 10, wherein the one or more performance metrics for an intersection comprise at least a measurement of traversal time for a particular vehicle through the intersection.

12. The system of claim 11, wherein the at least one processor is further configured to:
determine a first priority request message in the set of aggregated vehicle messages, the first priority request message indicating that the particular vehicle is requesting to traverse the intersection;
determine one or more priority request update messages in the set of aggregated vehicle messages, the one or more priority request update messages indicating that the particular vehicle is continuing to approach the intersection;
determine a first request cancellation message in the set of aggregated vehicle message, the first request cancellation message indicating that the particular vehicle has traversed the intersection; and
determine a traversal time for the particular vehicle through the intersection based upon timestamp information associated with the first priority request message and the first request cancellation message.

13. The method of claim 10, wherein the one or more performance metrics for a particular intersection comprise one or more of total number of vehicles passing through the intersection, total number of priority vehicles passing through the intersection, and traversal time information for vehicles passing through the intersection.

14. The system of claim 9, wherein the at least one processor is configured to perform further processing by being further configured to determine aggregated overall request response information for a particular intersection based upon signal status messages for the particular intersection as identified in the set of aggregated vehicle messages.

15. The system of claim 9, wherein the at least one processor is configured to perform further processing by being further configured to determine packet error ratio information for one or more devices associated with the connected vehicle system based upon the set of aggregated vehicle messages.

16. The system of claim 15, wherein the at least one processor is configured to determine the packet error ratio information by being further configured to calculate the number of dropped or missing packets over a period of time for the one or more devices associated with the connected vehicle system.
